(19) United States
(12) Patent Application Publication
(10) Pub. No.: US 2005/0096965 A1
(43) Pub. Date: May 5, 2005

(54) Method and apparatus of dynamic customer demand forecasting

(76) Inventors: Cheng-Hwa Liu, Hsinchu City (TW); Chin-Hsuen Chen, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/696,183

(22) Filed: Oct. 29, 2003

(51) Int. Cl. G06F 17/60

(52) U.S. Cl. 705/10

(57) ABSTRACT

A method of dynamic customer demand forecasting. The inventive method first inputs forecast rules, including a forecast base rule and customer defined rules. The method then calculates forecast hit rates of the forecast rules. Each forecast hit rate corresponds to a forecast rule. Next, the method selects a highest hit rate from the forecast hit rates. Finally, the method designates the forecast rule corresponding to the highest hit rate as a target rule. Afterwards, the method further provides the target rule to a capacity allocation model for capacity allocation.

### BACKGROUND OF THE INVENTION

1. Field of the Invention

The present invention relates to a capacity management technology and in particular to a method and apparatus of dynamic customer demand forecasting.

2. Description of the Related Art

In capacity management, the recognition of resources between customers and manufacturers is quite different. For example, customer demands are primarily concerned with products, while manufacturing capacity is concerned with actual manufacturing capacity distribution. Thus, customer demands must be properly mapped to actual manufacturing capacity for further utilization, such as capacity allocation. In other words, the relationship between the customer demands and the actual manufacturing capacity should be accurately linked. Generally, a forecast mechanism is established between customer demands and manufacturing capacity and a forecast rule is applied to the forecast mechanism for capacity mapping. Presently, the most current order is typically designated as the forecast rule as it contains the most current product and customer demand information.

One drawback of utilizing the most current order as the forecast rule is lack of flexibility. For example, the forecast rule must be updated if the most current order is changed, increasing the complexity of the forecast mechanism. Another drawback is that the most current order cannot provide an optimal solution for customers, especially at the point when the forecast mechanism is established, that is, when the forecast mechanism is underdeveloped. Satisfying customer expectations and ensuring mapping accuracy are main goals. Customer defined rules and a strict hit rate calculation method should be applied to the forecast mechanism.

Concerning the concept of customer defined rules, U.S. Pat. No. 6,434,514 discloses a rule based capacity management system for an inter office facility. The invention mainly discloses a computer program for monitoring specific pieces of equipment in a telecommunications network, including a presentation layer, a data layer, and a business layer. The inventive system receives rules from users and utilizes the received rules and the raw data to produce analytical reports.

Currently, there is no dynamic method for selecting forecast rules for a forecast mechanism that satisfies customers and manufacturers simultaneously.

### SUMMARY

Accordingly, an object of the invention is to provide a dynamic method to select forecast rules and utilize orders to calculate hit rates for evaluating the forecast rules.

To achieve the foregoing and other objects, the invention discloses a computer implemented method of dynamic customer demand forecasting. The method first inputs forecast rules. The forecast rules are integrated with a forecast base rule and customer defined rules. The method then calculates forecast hit rates of the forecast rules, evaluating by orders. Each hit rate corresponds to a forecast rule. Next, a highest hit rate is selected from the forecast hit rates. Finally, the forecast rule corresponding to the highest hit rate is designated as a target rule. The target rule is subsequently provided to a capacity allocation model for capacity allocation.

### BRIEF DESCRIPTION OF THE DRAWINGS

The present invention can be more fully understood by reading the following detailed description and examples with references made to the accompanying drawings, wherein:

FIG. 1 is a flowchart of the computer implemented method of dynamic customer demand forecasting.

FIG. 2 is a diagram of the apparatus of dynamic customer demand forecasting.

FIG. 3 is a diagram of the storage medium for storing a computer program providing a method of dynamic customer demand forecasting.

FIG. 4 is a diagram of the system of dynamic customer demand forecasting.

FIG. 5 is a diagram of the computer implemented method of dynamic customer demand forecasting according to one embodiment.

### DETAILED DESCRIPTION OF THE INVENTION

As summarized above, the present invention discloses a computer implemented method of dynamic customer demand forecasting. In one embodiment, the method first inputs forecast rules. The forecast rules comprise a forecast base rule and customer defined rules. The forecast base rule is produced according to the most current order. The forecast base rule is provided as a default rule in the calculation to prevent invalidation. The forecast base rule may be selected according to other principles, depending on the actual need. The customer defined rules may be input by customers in a user interface or other inputting tools. The forecast base rule and the customer defined rules are integrated into the forecast rules.

The method then calculates forecast hit rates of the forecast rules. Each hit rate corresponds to a forecast rule. The forecast hit rates are calculated according to orders. The orders are utilized to evaluate the forecast rules because the main goal of demand forecasting is to estimate the actual orders. In other words, the closer to the actual number of orders, the better the demand forecast is. Similarly, the calculation method of hit rates is not absolute. If the demand forecast must meet other requirements, the selection principles of the calculation method can then be modified.

Next, a highest hit rate is selected from the forecast hit rates and the forecast rule corresponding to the selected highest hit rate is designated as a target rule. It should be noted that the target rule is selected from the forecast rules and the forecast rules are integrated with the forecast base rule and customer defined rules. Thus, if there is no better rule than the default rule, i.e. the forecast base rule, the default rule will be selected, thus preventing an invalid selection resulting in calculation failure.

The target rule is then provided to a capacity allocation model for calculating capacity allocation. After the target rule is established, customers can input and map their demands to the actual manufacturing capacity according to the target rule. The dynamic forecasting method provides a trial and error method to select a target rule for demand capacity mapping, which is particularly useful for an immature forecast mechanism.

In addition, the invention discloses a storage medium for storing a computer program providing a method of dynamic customer demand forecasting. The method comprises the above mentioned steps.

Moreover, the invention provides an apparatus of dynamic customer demand forecasting. The apparatus comprises an input module, a calculation module, a selection module, and a designation module.

The input module inputs forecast rules. The forecast rules comprise a forecast base rule and customer defined rules. The forecast base rule is produced according to the most current order and provided as a default rule. The forecast base rule and the customer defined rules are integrated into the forecast rules.

The calculation module calculates forecast hit rates of the forecast rules. Each forecast hit rate corresponds to a forecast rule. The forecast base rule and the calculation method of the hit rates can be selected according to other principles, depending on the actual requirements.

The selection module selects a highest hit rate from the forecast hit rates. The designation module designates the forecast rule corresponding to the highest hit rate as a target rule. The inventive apparatus may further comprise a providing module for providing the target rule to a capacity allocation model for capacity allocation, such as manufacturing capacity distribution.

Furthermore, the invention discloses a system of dynamic customer demand forecasting. The inventive system comprises an operation computer and databases. The operation computer inputs forecast rules and calculates forecast hit rates generated by the forecast rules. Each forecast hit rate corresponds to a forecast rule. Again, the forecast rules are integrated with a forecast base rule and the customer defined rules. The forecast base rule is provided as a default rule.

The operation computer also selects a highest hit rate from the forecast hit rates and designates the forecast rule corresponding to the highest hit rate as a target rule. The operation computer may provide the target rule to a capacity allocation model for further utilization, such as calculating capacity allocation. Hit rates are calculated according to orders. The method of forecast base rule selection and hit rate calculation is not limited solely to this example, and may be altered according to the actual requirements.

The databases store the forecast rules, including the forecast base rule and the customer defined rules, the forecast hit rates, and the target rule. The databases can be data-type specific or integrated.

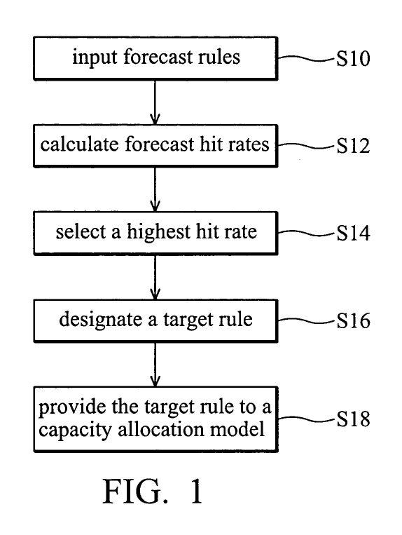

FIG. 1 is a flowchart of the computer implemented method of dynamic customer demand forecasting. The method first inputs forecast rules (step S10). The forecast rules comprise a forecast base rule and customer defined rules. The forecast base rule is produced according to the most current order. The forecast base rule is the default rule used in the calculation to prevent invalidation. The forecast base rule may be selected according to other principles, depending on actual customer requirements. The customer defined rules can be input through a user interface or other input medium. The forecast base rule and the customer defined rules are integrated into the forecast rules.

The method then calculates forecast hit rates of the forecast rules (step S12). Each hit rate corresponds to a forecast rule. The forecast hit rates are calculated according to orders. The calculation method of the hit rates can be modified. The main selection principle of the calculation method is to estimate actual orders.

Next, a highest hit rate is selected from the forecast hit rates (step S14) and the forecast rule corresponding to the highest hit rate is designated as a target rule (step S16). If there is no better rule than the forecast base rule according to the calculated hit rates, the forecast base rule is designated as the target rule, preventing calculation failure.

The target rule is then provided to a capacity allocation model for capacity allocation (step S18). Once the target rule is established, customers can input their demands and map their demands to the actual manufacturing capacity according to the target rule.

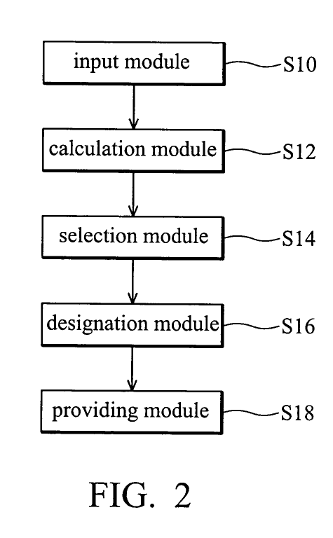

FIG. 2 is a diagram of the apparatus of dynamic customer demand forecasting. The inventive apparatus comprises an input module 10, a calculation module 12, a selection module 14, and a designation module 16.

The input module 10 inputs forecast rules. The forecast rules comprise a forecast base rule and customer defined rules. The forecast base rule is produced according to the most current order and provided as a default rule. The forecast base rule and the customer defined rules are integrated into the forecast rules.

The calculation module 12 calculates forecast hit rates of the forecast rule, each of which corresponds to a forecast rule. The forecast base rule and the calculation method of the hit rates can be selected according to other principles, depending on the actual requirements.

The selection module 14 selects a highest hit rate from the forecast hit rates. The designation module 16 designates the forecast rule corresponding to the highest hit rate as a target rule. The inventive apparatus may further comprise a providing module 18 for providing the target rule to a capacity allocation model for capacity allocation or other utilization.

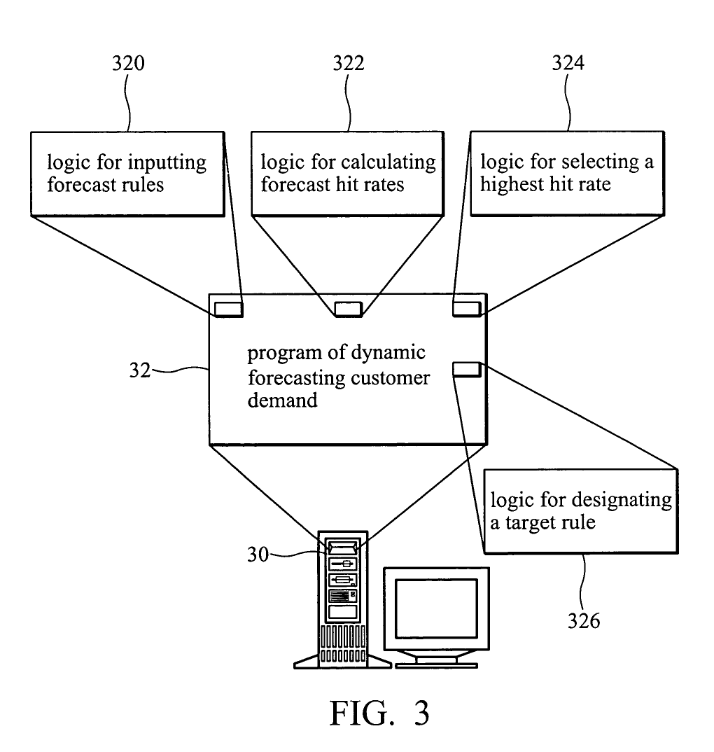

FIG. 3 is a diagram of the storage medium for storing a computer program providing a method of dynamic customer demand forecasting. The storage medium 30 stores a computer program 32. The computer program 32 provides a method of dynamic customer demand forecasting. The program mainly includes logic for inputting forecast rules 320, logic for calculating forecast hit rates 322, logic for selecting a highest hit rate 324, and logic for designating a target rule 326.

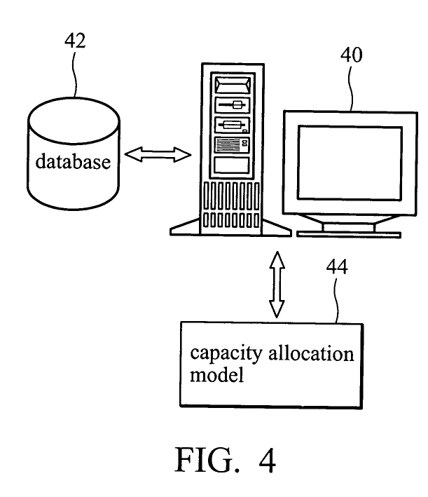

FIG. 4 is a diagram of the system of dynamically forecasting customer demand. The inventive system comprises an operation computer 40 and databases 42. The operation computer 40 inputs forecast rules and calculates forecast hit rates according to the forecast rules. Each forecast hit rate corresponds to a forecast rule. The composition and the selection principles of the forecast rules are as described above.

The operation computer 40 selects a highest hit rate from the forecast hit rates and designates the forecast rule corresponding to the highest hit rate as a target rule. The operation computer 40 may provide the target rule to a capacity allocation model 44 for further utilization, such as calculating capacity allocation. The calculation of the hit rates corresponds to orders. The databases 42 store the forecast rules, forecast hit rates, and the target rule. The databases 42 can be data-type specific or integrated.

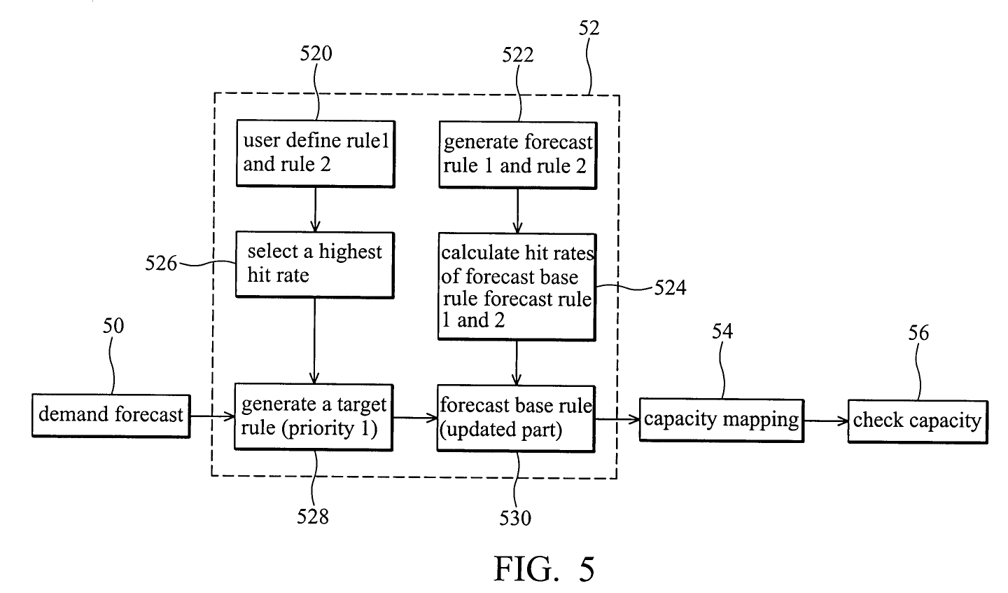

FIG. 5 is a diagram of the computer implemented method of dynamic customer demand forecasting according to one embodiment. In one embodiment, the customers demand forecast 50 is input and mapped into capacity 54 through a forecast mechanism 52. The mapped capacity is then checked with the actual manufacturing capacity 56, provided to a capacity allocation model for further utilization.

In the forecast mechanism 52, customer defined rule1 and rule2 are first input (520) and a forecast base rule is produced according to the most current order. The forecast base rule and the customer defined rules are integrated into the forecast rules, forecast rule1 and forecast rule2 (522).

Forecast hit rates of the forecast rules are then calculated (524). Each hit rate corresponds to a forecast rule. The forecast hit rates are calculated according to orders. The orders are utilized to evaluate the forecast rules as the main goal of demand forecasting is to estimate the actual orders.

Next, the highest hit rate is selected from the forecast hit rates (526) and the forecast rule corresponding to the highest hit rate is designated as a target rule (528). If there is no better rule than the forecast base rule, the forecast base rule is selected (530), preventing an invalid selection resulting in calculation failure. The target rule in the forecast mechanism 52 can provide more accurate and consistent mapping relationship between customer demand and actual capacity. Once the customers input new customer defined rules, the mentioned steps will be operated to produce a new target rule dynamically, satisfying customer expectations.

Thus, a method of dynamic forecasting customer demand is provided by embodiments of the invention. The disclosed method allows customers to input customer defined forecast rules and utilizes orders to evaluate the hit rates of the forecast rules, satisfying customer expectations and ensuring the accuracy of the mapping relationship.

It will be appreciated from the foregoing description that the system and method described herein provide a dynamic and robust solution to the customer demand forecasting problem. If, for example, the selection of the forecast base rule or the method of hit rate calculation is altered, the system and method of the present invention can adjusted accordingly.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over a transmission medium, such as electrical wire, cable, fiberoptics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A computer implemented method of dynamic customer demand forecasting, comprising using a computer to perform the steps of:
inputting at least one forecast rule;
calculating at least one forecast hit rate, each of which corresponds to a forecast rule;
selecting a highest hit rate from the forecast hit rate; and
designating the forecast rule corresponding to the highest hit rate as a target rule.

2. The computer implemented method of dynamic customer demand forecasting as claimed in claim 1, further comprising providing the target rule to a capacity allocation model for capacity allocation.

3. The computer implemented method of dynamic customer demand forecasting as claimed in claim 1, wherein the forecast rule comprises a forecast base rule and at least one customer defined rule.

4. The computer implemented method of dynamic customer demand forecasting as claimed in claim 3, wherein the input step further comprises integrating the forecast base rule and the customer defined rule into the forecast rule.

5. The computer implemented method of dynamic customer demand forecasting as claimed in claim 3, wherein the forecast base rule is produced according to the most current order.

6. The computer implemented method of dynamic customer demand forecasting as claimed in claim 1, wherein the forecast hit rate is calculated according to orders.

7. An apparatus of dynamic customer demand forecasting, comprising:
an input module, inputting at least one forecast rule;
a calculation module, coupled to the input module, calculating at least one forecast hit rate, each of which corresponds to a forecast rule;
a selection module, coupled to the calculation module, selecting a highest hit rate from the forecast hit rate; and
a designation module, coupled to the selection module, designating the forecast rule corresponding to the highest hit rate as a target rule.

8. The apparatus as claimed in claim 7, further comprising a providing module, coupled to the designation module, providing the target rule to a capacity allocation model for capacity allocation.

9. The apparatus as claimed in claim 7, wherein the forecast rule comprises a forecast base rule and at least one customer defined rule.

10. The apparatus as claimed in claim 9, wherein the input module further integrates the forecast base rule and the customer defined rule into the forecast rule.

11. The apparatus as claimed in claim 9, wherein the forecast base rule is produced according to the most current order.

12. The apparatus as claimed in claim 7, wherein the forecast hit rate is calculated according to orders.

13. A storage medium for storing a computer program providing a method of dynamic customer demand forecasting, the method comprising the steps of:
inputting at least one forecast rule;
calculating at least one forecast hit rate, each of which corresponds to a forecast rule;
selecting a highest hit rate from the forecast hit rate; and
designating the forecast rule corresponding to the highest hit rate as a target rule.

14. The storage medium as claimed in claim 13, further comprising providing the target rule to a capacity allocation model for capacity allocation.

15. The storage medium as claimed in claim 13, wherein the forecast rule comprises a forecast base rule and at least one customer defined rule.

16. The storage medium as claimed in claim 15, wherein the input step further comprises integrating the forecast base rule and the customer defined rule into the forecast rule.

17. The storage medium as claimed in claim 15, wherein the forecast base rule is produced according to the most current order.

18. The storage medium as claimed in claim 13, wherein the forecast hit rate is calculated according to orders.

19. A system of dynamic customer demand forecasting, comprising:
an operation computer, inputting at least one forecast rule, calculating at least one forecast hit rate, each of which corresponds to a forecast rule, selecting a highest hit rate from the forecast hit rate, and designating the forecast rule corresponding to the highest hit rate as a target rule; and
at least one database, coupled to the operation computer, storing the forecast rule, the forecast hit rate, and the target rule.

20. The system as claimed in claim 19, wherein the operation computer further provides the target rule to a capacity allocation model for capacity allocation.

21. The system as claimed in claim 19, wherein the forecast rule comprises a forecast base rule and at least one customer defined rule.

22. The system as claimed in claim 21, wherein the operation computer further integrates the forecast base rule and the customer defined rules into the forecast rule.

23. The system as claimed in claim 21, wherein the forecast base rule is produced according to the most current order.

24. The system as claimed in claim 19, wherein the forecast hit rate is calculated according to orders.
